(19) United States
(12) Patent Application Publication
(10) Pub. No.: US 2026/0092811 A1
(43) Pub. Date: Apr. 2, 2026

(54) MULTI-SPECTRAL OPTICAL DETECTOR WITH INTEGRATED TEST

(71) Applicant: Spectronix Ltd., Sderot (IL)

(72) Inventors: Boaz HAREL, Tel Aviv (IL); Uzziel SHEINTOP, Lod (IL); Tsviel BOUHBUT, Be’er Sheva (IL); Dimitriy GRIGOROVITCH, Be'er Sheva (IL)

(21) Appl. No.: 18/901,339

(22) Filed: Sep. 30, 2024

(51) Int. Cl. G01J 3/02; G01J 3/28

(52) U.S. Cl. CPC G01J 3/0294; G01J 3/0205; G01J 2003/283

(57) ABSTRACT

A multi-spectral optical detector includes a housing having a window. A first channel is disposed within the housing proximate the window and is sensitive to electromagnetic radiation in a first frequency range. A second channel is disposed within the housing proximate the window and is sensitive to electromagnetic radiation in a second frequency range that is different than the first frequency range. A digitizer is operably coupled to the first and second channels and is configured to provide digital indication relative to electromagnetic radiation received by the first and second channels. A processor is coupled to the digitizer to receive the digital indication and generate an output signal based thereon. At least one emitter is disposed within the housing and is operably coupled to the process. The at least one emitter is configured to inject a test signal into at least one of the first and second channels to test operation of the at least one first and second channel. A method of operating a multi-channel optical detector is also provided.

### BACKGROUND

The process control and monitoring industry supports a wide range of process industries. Some of the process industries may employ or process materials that are highly flammable or even explosive. Examples of such industries include chemical processing facilities as well as petroleum extraction and refining. In such environments, fires and explosions are a significant hazard. In these highly volatile environments, it is useful and sometimes required to use one or more optical detectors, such as optical flame detectors, that detect any flame in the process environment so that such flame can be quickly extinguished.

### SUMMARY

A multi-spectral optical detector includes a housing having a window. A first channel is disposed within the housing proximate the window and is sensitive to electromagnetic radiation in a first frequency range. A second channel is disposed within the housing proximate the window and is sensitive to electromagnetic radiation in a second frequency range that is different than the first frequency range. A digitizer is operably coupled to the first and second channels and is configured to provide digital indication relative to electromagnetic radiation received by the first and second channels. A processor is coupled to the digitizer to receive the digital indication and generate an output signal based thereon. At least one emitter is disposed within the housing and is operably coupled to the process. The at least one emitter is configured to inject a test signal into at least one of the first and second channels to test operation of the at least one first and second channel. A method of operating a multi-channel optical detector is also provided.

### BRIEF DESCRIPTION OF THE DRAWINGS

FIG. 1 is a system block diagram of a multi-channel optical sensor with which embodiments described herein are particularly useful.

FIG. 2 is a system block diagram of a multi-channel optical sensor in accordance with an embodiment of the present invention.

FIG. 3 is a graph of signal intensity for multiple IR sensors of an optical detector with internal an internal self-test in accordance with an embodiment of the present invention.

FIG. 4 is a flow diagram of a method of operating an optical detector in accordance with an embodiment of the present invention.

FIG. 5 is a system block diagram of a multi-channel optical sensor in accordance with another embodiment of the present invention.

FIG. 6 is a system block diagram of a pair of multi-channel optical sensors in accordance with another embodiment of the present invention operating in a cloud environment.

### DETAILED DESCRIPTION OF ILLUSTRATIVE EMBODIMENTS

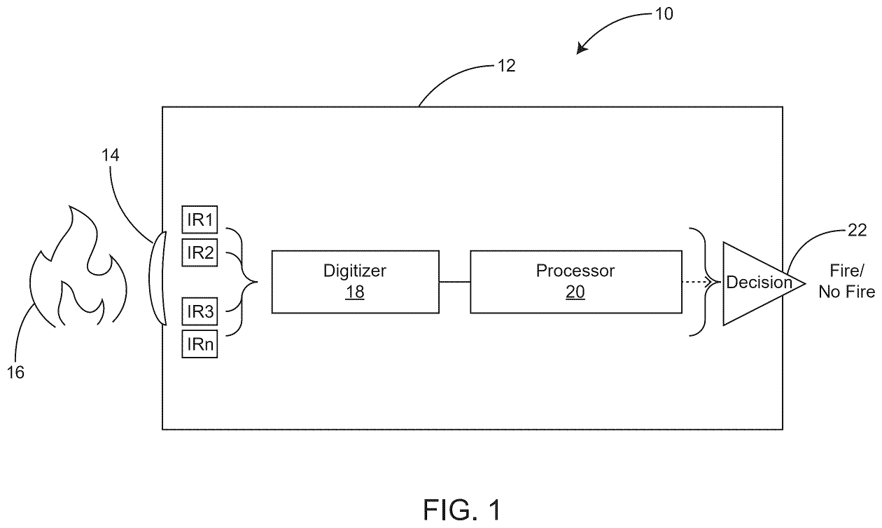

FIG. 1 is a system block diagram of a multi-channel optical sensor with which embodiments described herein are particularly useful. Multi-channel optical sensor 10, when used in the context of optical flame detection, is a device designed to detect the presence of flames by analyzing emission across multiple spectral bands or channels. Using multiple channels provides a number of advantages. First, detection accuracy is enhanced since different materials combust with different spectral characteristics. A multi-channel sensor can detect various types of fires by analyzing different parts of the electromagnetic spectrum, including ultraviolet (UV), visible light, and infrared (IR) bands. Second, the rate of false alarms is reduced by comparing the intensity of emission across several channels, these sensors can differentiate between actual flames and other emission sources that might cause false alarms, such as sunlight, artificial lights, or reflections. Third, reliability is improved since multi-channel sensors can operate effectively in a variety of environmental conditions, reducing the risk of detection failures due to factors like dust, moisture, or other atmospheric obscurants.

Sensor 10 includes a housing 12 having a lens or window 14 through which flames 16 are visible. Flames 16 emit a broad spectrum of infrared radiation. The sensor 10 includes a plurality of individual IR sensors IR1, IR2, IR3, . . . IRₙ, where each individual sensor is sensitive to a particular range, band or IR wavelength. Thus, each individual sensor is essentially tuned or otherwise focused to relevant flame emission wavelengths. Each of IR sensors IR1, IR2, IR3, . . . IRₙ is operably coupled to digitizer 18, which includes circuitry to convert an analog signal of an individual IR sensor to a digital representation thereof. Digitizer 18 is coupled to processor 20 and is configured to provide the digital representations related to the various IR sensors to processor 20.

Processor 20 is any suitable device that is able to execute programmatic steps or functions to provide various features of sensor 10. Examples of such devices include digital signal processors, microcontrollers, field programmable gate arrays, and application specific integrated circuits. In some examples, processor 20 is a microprocessor. Digitizer 18 provides digitized representations of the IR sensor signals to processor 20 for signal processing. Processor 20 processes the digitized signals from the IR sensors and analyzes the signals from each IR sensor. Processor 20 attempts to identify specific patterns associated with flame flicker and intensity. In order to analyze the flame flicker frequency, processor 20 generally transforms the signal from time domain to frequency Fast Fourier Transform (FFT). By comparing the output of multiple IR sensors, processor 20 can distinguish between a flame and other IR sources like sunlight, hot machinery, or artificial lighting. The feature is achieved by analyzing the intensity and frequency response of each channel. Real flame is characterized as low frequency signals with response of 1-5 Hz, and by high intensity signal at signal channels together with low intensity at reference channels. The correlation (frequency response) of the channels is expected to be high, but not full correlation, which would indicate an artificial signal. This multi-spectral analysis reduces false alarms. Processor 20 executes methods to apply such analysis to calculate the integral of the signals which will correspond to flame intensity, calculate ratios between the channels for understanding the signal channels are higher than the reference channels. The last part is to compare the frequency behavior between the different channels to measure the correlation between them.

When processor 20 confirms the presence of a flame, it generates an output 22, such as triggering an alarm and/or other suitable actions. Sensor 10 can also initiate automatic safety measures, such as shutting down equipment and/or activating fire suppression systems.

Traditional multi-channel optical sensors are very important in detecting optical emissions in various environments. However, these devices generally lack the ability to continually assess their own operational integrity. Consequently, any failure or degradation in their functionality can remain undetected until the next manual inspection or maintenance check, potentially leading to undesirable outcomes in the event of an undetected fault. Further, multi-channel optical sensors, as employed in various applications, are inherently susceptible to malfunctions stemming from inadvertent electrical or optical crosstalk among the optical channels.

Optical crosstalk in an IR sensor occurs when unwanted infrared signals from adjacent sensors interfere with the sensor's intended detection signal. This interference can lead to inaccurate readings or false alarms, reducing the sensor's overall accuracy and reliability

Such faults can manifest as unintended shortcuts or signal interference between channels, leading to compromised sensor performance, erroneous data acquisition, or failure in accurately detecting or measuring the intended optical signals. This issue is particularly prevalent in environments where dense integration of optical channels is necessary, and the precise segregation of optical paths is critical for the sensor's operational integrity and accuracy. An advanced Multi channel optical sensor can host up to 256 optical elements in a physical size of 10 millimeters, giving a size of each channel of 30 micrometers and separation between channels of 10 micrometers.

With such small sizes, any problem in the assembly process can lead to shortcuts between channels, resulting getting wrong information from the sensor.

Current optical flame detectors are tested using an external light source, which requires additional hardware, footprint, and only allows the use of a single light source to test all channels. This can result in an inaccurate signal reaching each channel, due to mechanical tolerances and sizes of the external light source. As a result, such a sensor can be tested to ensure that sensor responds to light, but it generally not possible to analyze the response of each channel separately, as all channels are exposed to the same level of signal.

In accordance with embodiments of the present invention, an optical sensor is provided with an internal self-test feature. Such internal self-testing, in some embodiments, may continuously validate the internal hardware components of the multi-channel optical sensors. This process preferably occurs in real-time, alongside the device's primary detection tasks, without interrupting or impairing the device's ability to detect optical signals. However, it is expressly contemplated that such internal self-testing may also be performed periodically and/or in response to user input. Furthermore, embodiments of the present invention include a method for evaluating the integrity and performance of multi-channel optical sensors by employing a plurality of distinct energy sources. This method involves sequentially directing energy from each of these sources into the optical channels and subsequently recording the response of each channel to the respective energy inputs. The collected response data is then processed by processor 20 to determine the presence or absence of optical crosstalk among the channels. By measuring and comparing the response of each channel to the various energy sources, the method ensures the accurate discrimination of signals corresponding to each channel, thereby enhancing the fidelity and reliability of the multi-channel optical sensor system.

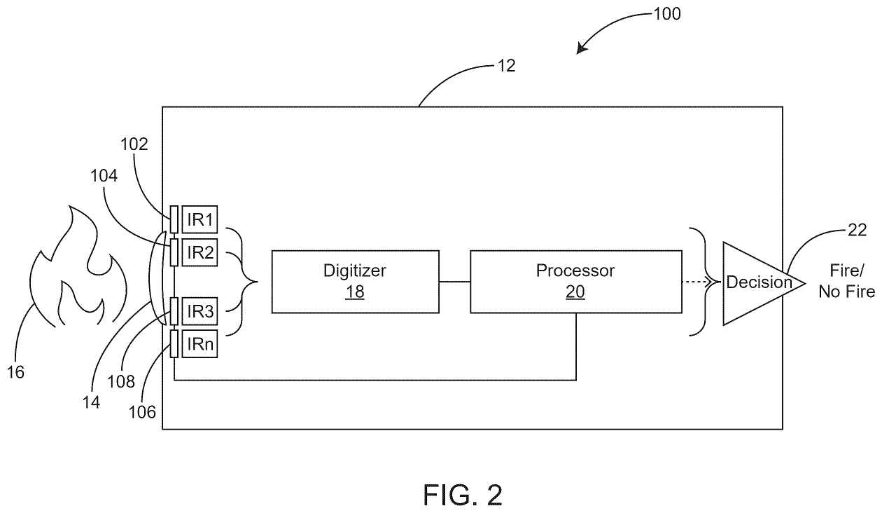

FIG. 2 is a system block diagram of a multi-channel optical sensor in accordance with an embodiment of the present invention. Sensor 100 bears some similarities to sensor 10, and like components are numbered similarly. Sensor 100 includes sensor housing 12 containing various IR sensors, such as IR1, IR2, IR3, and IRₙ as shown. Each of the various IR sensors is operably coupled to digitizer 18, which provides digital representations of signals from the IR sensors to processor 20. However, sensor 100 includes an internal illumination source that is operably coupled to processor 20, such that processor 20 controls the illumination source. In the illustrated embodiment, the internal illumination source is in the form of a number of emitters 102, 104, 106, and 108. As shown in FIG. 2, an emitter is positioned proximate each IR sensor. More specifically: emitter 102 is positioned proximate sensor IR1; emitter 104 is positioned proximate sensor IR2; emitter 106 is positioned proximate sensor IR3; and emitter 108 is positioned proximate sensor IRₙ. Each emitter may be configured to have an emission wavelength that matches its respective IR sensor. Alternatively, one or more emitters may have a broader emission spectrum than their respective IR sensors. In some cases, the emitter may be a broad-spectrum emitter, such as an incandescent light or strobe. In some embodiments, the proximity of the emitter to each respective IR sensor may be generated by mounting a discrete emitter on a circuit board proximate each discrete IR sensor. In other embodiments, the IR emitter may be mounted to the same piece of silicon (i.e., a composite silicon component having a number of emitters and IR sensors) as the IR sensor. In still other embodiments, an IR emitter may be disposed within each respective IR sensor.

All emitters 102, 104, 106, and 108 are operably coupled to processor 20 such that processor 20 controls the operation of each individual emitter. Accordingly, processor 20 may energize emitter 102 and determine whether sensor IR1 has an acceptable response or detection to the emitted radiation. Additionally, processor 20 can also detect whether any other IR sensors sense the emission from emitter 102, which would be indicative of crosstalk. Such crosstalk may be due to illumination from emitter 102 reaching an IR sensor that is different than sensor IR1 and/or it may be indicative of an electrical fault that allows the signal from sensor IR1 to appear as a signal from another IR sensor, such as sensor IR2. In either case, such detection is indicative of a fault that processor 20 can provide locally and/or to a remote device.

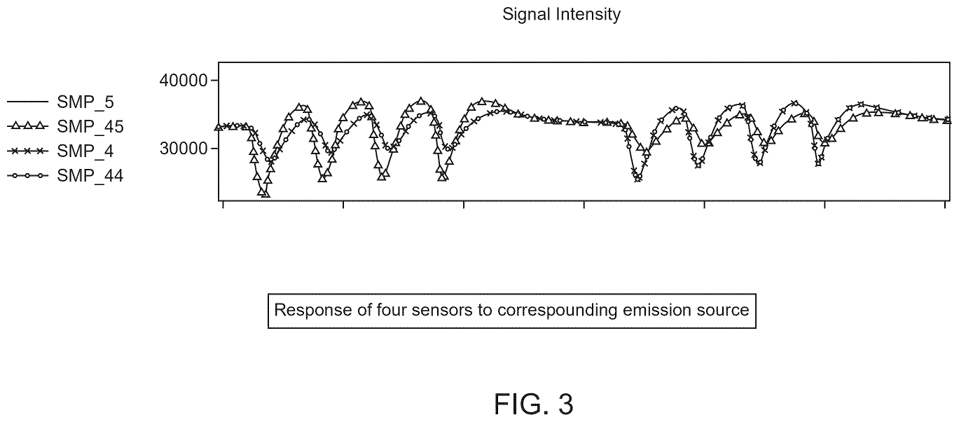

FIG. 3 is a graph of signal intensity for multiple IR sensors of an optical detector with internal an internal self-test in accordance with an embodiment of the present invention. FIG. 3 shows the sensor response to illumination from respective integrated energy source, such as emitters 102, 104, 106, and 108. During normal sensor operation, an energy source within housing 12 (shown in FIG. 2) emits optical energy which is received and detected by IR sensors IR1, IR2, IR3, and IRₙ.

Embodiments described herein generally include one or more emission sources that are integrated within the housing of a multi-channel sensor apparatus and positioned proximally to respective channels/detectors within the multi-channel sensor apparatus. Preferably each emission source is operationally paired with a corresponding channel/detector. The activation of said emission sources is preferably executed in a sequential manner, facilitating the measurement of each channel's response to its associated emission source. Analyzing the response of each channel/detector allows the sensitivity of each channel/detector to be calculated and compensated for such that there is no diminution of sensitivity over time. This configuration ensures the ongoing accuracy and reliability of the multi-channel sensor system, preserving its capacity to perform critical detection functions without degradation.

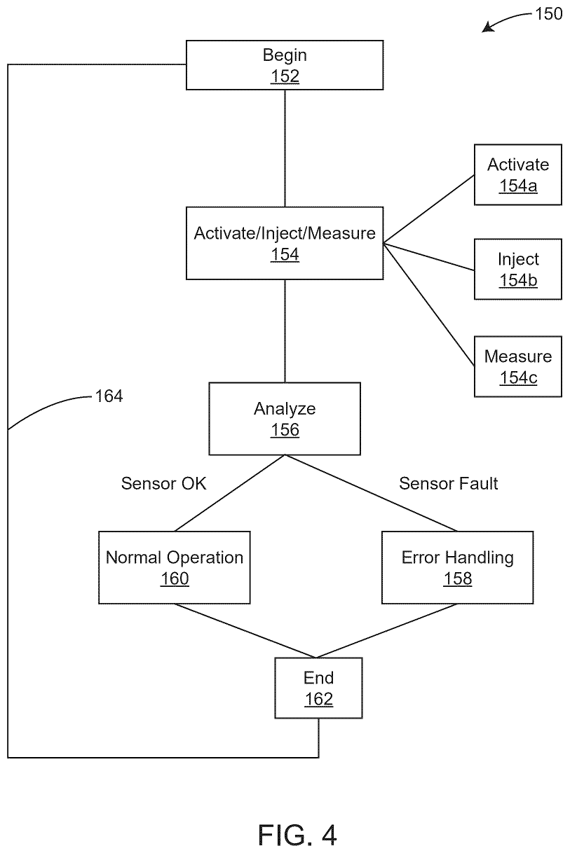

FIG. 4 is a flow diagram of a method of operating an optical detector in accordance with an embodiment of the present invention. Method 150 begins at block 152 where processor 20 triggers or otherwise initiates a self-test using one or more internal emission sources, such as emitters 102, 104, 106, and 108. Method 150 continues at block 154 where processor 20 activates one or more channels/IR sensors under test, as indicated at block 154a. In some embodiments, the channels/IR sensor are activated sequentially. However, in other embodiments, multiple channels/IR sensor may be activated simultaneously as long as the channels/detectors are sufficiently spaced that crosstalk (optical and/or electrical) is not possible. Next, processor 20 controls one or more emitters 102, 104, 106, 108 to inject a predefined test signal into each channel/IR detector to simulate one or more real operational scenarios, as indicated at block 154b. The pre-definition of the test signal is an important feature as it lets processor 20 disambiguate channel response from ambient and/or flame signals. Next, in block 154, IR sensor response to the injected test signal is measured or otherwise transduced by digitizer 18 and provided to processor 20, as indicated at block 154c.

At block 156, processor 20 compares the response of each channel/IR detector to an expected response outcome that is predefined for each test signal. Deviations between the measured channel response and the expected channel response are analyzed to identify potential sensor malfunctions or system inaccuracies. In some embodiments, the deviation of an individual channel from an expected response can simply be compared to a predefined threshold (i.e., 10%) and if the deviation exceeds the predefined threshold, processor 20 can generate a sensor fault and/or initiate error handling, as indicated by block 158. In another example, if the deviation exceeds the predefined threshold, processor 20 can proceed by ignoring or otherwise attenuating the effect of the failing channel in the overall detector operation. In another example, if processor 20 should detect a response in a channel/IR sensor that is not the intended recipient of the injected test signal, processor 20 can also proceed to block 158 and indicate a sensor fault. Additionally, the response of the channel/IR sensor can be ignored or otherwise attenuated in future system operation. If all channels/IR detectors provide responses to the injected test signals that match the expected response or match within a selected amount, processor 20 determines that the system is functioning properly and control passes to block 160, where normal system operation continues. Method 150 ends at block 162 but can repeat or iterate continuously or at a selected interval, as indicated by line 164.

As described above, embodiments disclosed herein generally provide one or more energy sources disposed within a housing of an optical detection device to measure channel response simultaneously during normal operation (i.e., in the background) thereby allowing precise detection of optical and/or electrical cross-talk. This allows the multi-channel optical sensor, in accordance with various embodiments, to conduct on-going self-assessments of the optical sensor without interrupting normal detection capabilities. Accordingly, embodiments described herein allow the device to identify and report malfunctions in real-time, ensuring the multi-channel optical sensor's operational integrity is always maintained.

The response of each channel/IR sensor is characterized by measuring the channel/IR sensor and comparing the response with other channels/IR sensor. Unique processing of the channel/IR sensor response to the pre-defined test signal(s) facilitates detection of subtle anomalies that may indicate impending failures or degradation of performance.

Embodiments described herein generally include an integrated hardware and software system that combines hardware modifications and software enhancements to implement the internal self-test feature. It is believed that such a system will be compatible with and provide seamless operation within existing optical detection frameworks. Additionally, the internal self-testing can operate autonomously, requiring no external inputs or activations, ensuring uninterrupted optical detection.

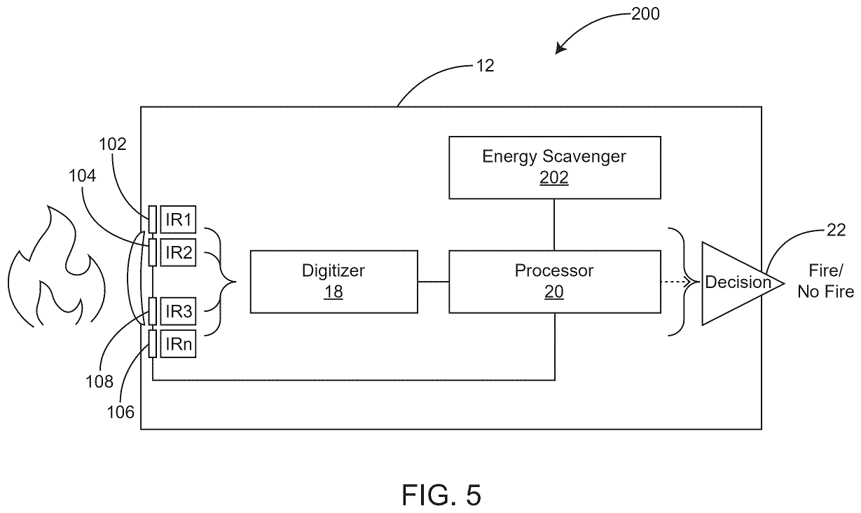

FIG. 5 is a system block diagram of a multi-channel optical sensor in accordance with another embodiment of the present invention. Sensor 200 bears some similarities to sensor 100 (shown in FIG. 2), and like components are numbered similarly. Embodiments of the present invention are particularly applicable to battery-powered devices. Given that embodiments generally add the additional functionality of energizing one or more emitters, such as emitter 102, 104, 106, and 108 within housing 12, it is possible that utilizing devices in accordance with disclosed embodiments may consume battery power faster than prior devices. Accordingly, optical detector 200 includes an energy scavenger 202 that is operable coupled to processor 20. Energy scavenger 202 is configured to generate electrical energy for sensor 200 from ambient sources of energy available to sensor 200. In one example, energy scavenger 202 includes one or more solar cells that convert sunlight to electricity. In another example, energy scavenger includes a thermoelectric generator that converts thermal energy differences between two surfaces into electricity. In still another example, energy scavenger can include a vibrational generator that converts vibrational motion into electricity. In still another example, energy scavenger 202 includes a wind energy generator that is configured to drive an electrical generator with wind power. Finally, embodiments include any combinations of the various forms of energy scavenging listed above.

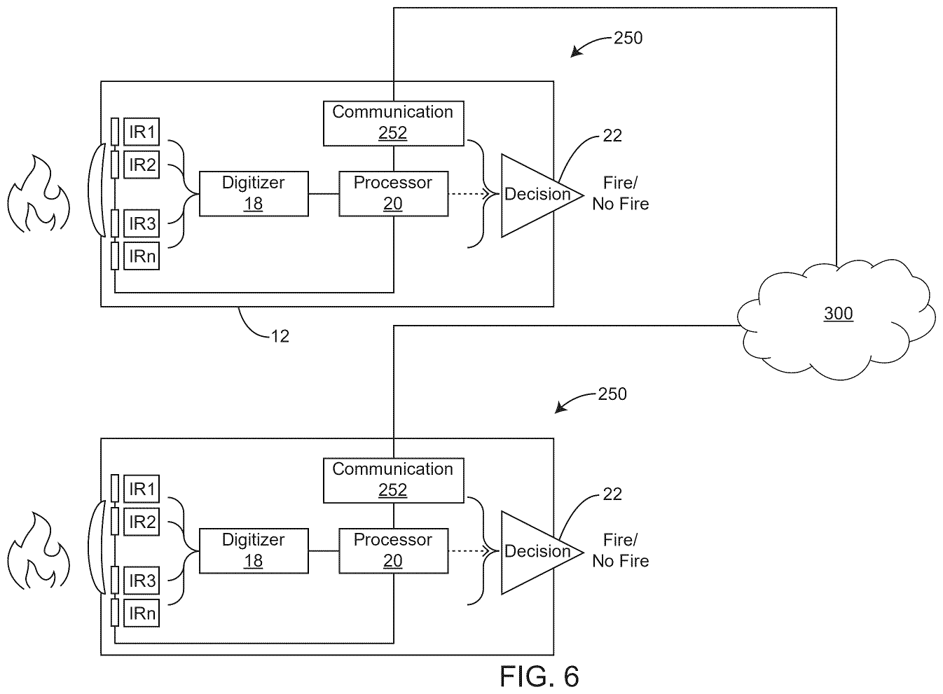

FIG. 6 is a system block diagram of a pair of multi-channel optical sensors in accordance with another embodiment of the present invention operating in a cloud environment. Each sensor 250 shown in FIG. 6 includes a communication module 252 coupled to a processor 20 and operably coupled to cloud computing system 300. Communication module 252 allows processor 20 to communicate with a remote device, such as a cloud computing system 300. Such communication can take any suitable form but is preferably wireless communication. Examples of wireless communication include, without limitation: the WirelessHART process communication protocol (IEC62591); a cellular communication protocol such as GPRS, UMTS, CDMA2000, LTE, LTE-M, NB-IOT, WiMax, 5G NR.; a WiFi standard, such as IEEE 802.11 b/g/n/a/ac/ax/be; and LoRaWAN protocol (ITU-T Y.4480). Leveraging cloud-based analytics, such as that provided by cloud resource 300, enables advanced data analysis, predictive maintenance, and remote monitoring capabilities. Such cloud-based analytics may also enable more sophisticated diagnostics, trend analysis, and preemptive actions based on aggregated data from multiple sensor 250.

Although the present invention has been described with reference to preferred embodiments, workers skilled in the art will recognize that changes may be made in form and detail without departing from the spirit and scope of the invention.

What is claimed is:

1. A multi-spectral optical detector comprising:
a housing having a window;
a first channel disposed within the housing proximate the window and being sensitive to electromagnetic radiation in a first frequency range;
a second channel disposed within the housing proximate the window and being sensitive to electromagnetic radiation in a second frequency range that is different than the first frequency range;
a digitizer operably coupled to the first and second channels, the digitizer being configured to provide digital indication relative to electromagnetic radiation received by the first and second channels;
a processor coupled to the digitizer to receive the digital indication and generate an output signal based thereon; and
at least one emitter disposed within the housing and operably coupled to the process, the at least one emitter being configured to inject a test signal into at least one of the first and second channel to test operation of the at least one first and second channel.

2. The multi-spectral optical detector of claim 1, wherein the at least one emitter includes a plurality of emitters and wherein a first emitter of the plurality of emitters is disposed proximate the first channel and a second emitter of the plurality of emitters is disposed proximate the second channel.

3. The multi-spectral optical detector of claim 2, wherein the first emitter has an emission wavelength in the first frequency range.

4. The multi-spectral optical detector of claim 3, wherein the second emitter has an emission wavelength in the second frequency range.

5. The multi-spectral optical detector of claim 1, and further comprising at least one additional channel disposed within the housing proximate the window and being sensitive to electromagnetic radiation in at least one additional frequency range that is different than the first frequency range and the second frequency range.

6. The multi-spectral optical detector of claim 5, wherein the at least one emitter includes a plurality of emitters and wherein a first emitter of the plurality of emitters is disposed proximate the first channel and a second emitter of the plurality of emitter is disposed proximate the second channel and at least one additional emitter is disposed proximate each respective at least one additional channel.

7. The multi-spectral optical detector of claim 1, wherein the multi-spectral optical sensor includes, in addition to the first and second channels, over 200 additional channels each being sensitive to electromagnetic radiation in a different range, and wherein optical elements of the channels are mounted within a physical size of 10 millimeters.

8. The multi-spectral optical detector of claim 1, wherein the first channel and the second channel are spaced apart by about 10 micrometers.

9. The multi-spectral optical detector of claim 1, wherein the processor is configured to identify crosstalk between the first and second channel and provide an indication of crosstalk.

10. The multi-channel optical detector of claim 1, wherein the multi-channel optical detector is a flame detector and the first frequency range and second frequency range are targeted to spectral characteristics of flame.

11. The multi-channel optical detector of claim 1, wherein the processor is configured to control the at least one emitter to perform a self-test.

12. The multi-channel optical detector of claim 11, wherein the processor is configured to perform the self-test as a background task.

13. The multi-channel optical detector or claim 1, wherein the test signal is a pre-defined test signal.

14. The multi-channel optical detector of claim 1, and further comprising an energy scavenger disposed within the housing and coupled to the processor, the energy scavenger being configured to generate electricity from ambient potential energy proximate the multi-channel optical detector.

15. The multi-channel optical detector of claim 14, wherein the energy scavenger is configured to generate electricity from at least one of: solar radiation, thermal energy, motion, and wind.

16. The multi-channel optical detector of claim 1, and further comprising communication circuitry coupled to the processor and configured to communicate with a remote device.

17. The multi-channel optical detector of claim 16, wherein the processor is configured to provide channel response information to the remote device for remote analytics.

18. A method of operating a multi-channel optical detector, the method comprising:
activating a plurality of channels of the optical detector;
injecting a test signal into each activated channel using an emitter disposed within the multi-channel optical detector;
measuring a response of each channel to the injected test signal; and
comparing the measured response of each channel to an expected response and generating a self-test diagnostic output based on the comparison.

19. The method of claim 18, wherein activating the plurality of channels and injecting the test signal are performed sequentially for each channel of the plurality of channels.

20. The method of claim 18, wherein the test signal is a predefined test signal.
